(19) United States
(12) Patent Application Publication
(10) Pub. No.: US 2023/0308741 A1
(43) Pub. Date: Sep. 28, 2023

(54) IMAGE PROCESSING METHOD AND NON-TRANSITORY COMPUTER READABLE STORAGE MEDIUM

(71) Applicant: Realtek Semiconductor Corporation, Hsinchu (TW)

(72) Inventors: Yu-Chi TSAI, Hsinchu (TW); Wen-Tsung HUANG, Hsinchu (TW); Han-Yang WANG, Hsinchu (TW)

(21) Appl. No.: 18/048,855

(22) Filed: Oct. 23, 2022

(30) Foreign Application Priority Data
Mar. 28, 2022 (TW) 111111711

(51) Int. Cl. H04N 23/62; G06T 5/00; G06T 3/40; H04N 7/18; H04N 23/63

(52) U.S. Cl. CPC H04N 23/62; G06T 5/002; G06T 3/40; H04N 7/185; H04N 23/631

(57) ABSTRACT

An image processing method includes following operations: executing, by a transmitter device, a driver program of a camera to acquire a dynamic image; executing, by the transmitter device, the driver program to acquire a plurality of position data of input information, in which the plurality of position data is associated with the transmitter device; executing, by the transmitter device, the driver program to perform a superimpose process on the input information and the dynamic image according to the plurality of position data so as to generate a superimposed dynamic image; and executing, by the transmitter device, the driver program to display the superimposed dynamic image.

### RELATED APPLICATIONS

This application claims priority to Taiwanese Application Serial Number 111111711, filed Mar. 28, 2022, which is herein incorporated by reference.

### BACKGROUND

### Technical Field

The present disclosure relates to image technology. More particularly, the present disclosure relates to an image processing method and a non-transitory computer readable storage medium that can improve the interactivity and communication convenience of dynamic images.

### Description of Related Art

With developments of technology, various electronic devices equipped with cameras are developed. For example, laptop computers, desktop computers, tablet computers, smart phones, wearable electronic devices, and automotive devices can be equipped with cameras. Users can utilize the cameras in these devices to capture dynamic images and send the dynamic images to other electronic devices instantaneously to interact or communicate with other users.

### SUMMARY

Some aspects of the present disclosure are to provide an image processing method. The image processing method includes following operations: executing, by a transmitter device, a driver program of a camera to acquire a dynamic image; executing, by the transmitter device, the driver program to acquire a plurality of position data of input information, in which the plurality of position data is associated with the transmitter device; executing, by the transmitter device, the driver program to perform a superimpose process on the input information and the dynamic image according to the plurality of position data so as to generate a superimposed dynamic image; and executing, by the transmitter device, the driver program to display the superimposed dynamic image.

Some aspects of the present disclosure are to provide a non-transitory computer readable storage medium. The non-transitory computer readable storage medium is configured to store a driver program of a camera. When a processor in a transmitter device executes the driver program, the processor performs following operations: acquiring a dynamic image; acquiring a plurality of position data of input information, in which the plurality of position data is associated with the transmitter device; performing a superimpose process on the input information and the dynamic image according to the plurality of position data so as to generate a superimposed dynamic image; and controlling a display in the transmitter device to display the superimposed dynamic image.

As described above, the image processing method of the present disclosure does not need additional hardware devices (e.g., a physical whiteboard) and can utilize a single driver program (e.g., a driver program of a camera) to superimpose the input information and the dynamic image so as to display the superimposed image instantaneously. Accordingly, interactivity and communication convenience of dynamic images can be improved. Overall, the present disclosure has advantages of simple structures and ease to use.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an image system according to some embodiments of the present disclosure.

FIG. 2 is a flow diagram of an image processing method according to some embodiments of the present disclosure.

FIG. 3 is a schematic diagram of a dynamic image according to some embodiments of the present disclosure.

FIG. 4 is a schematic diagram of input information according to some embodiments of the present disclosure.

FIG. 5 is a schematic diagram of handwriting line information according to some embodiments of the present disclosure.

FIG. 6 is a schematic diagram of a superimposed dynamic image according to some embodiments of the present disclosure.

FIG. 7 is a schematic diagram of a video conference image according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

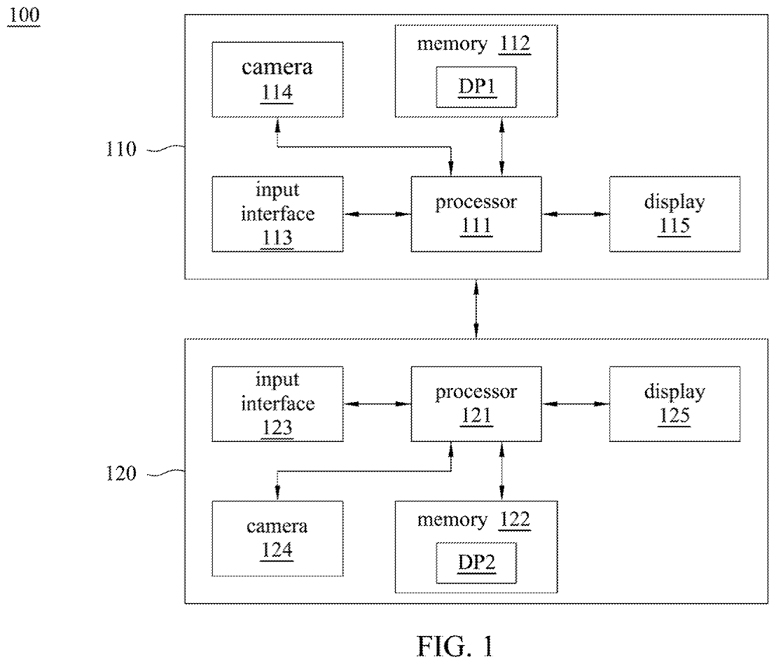

Reference is made to FIG. 1. FIG. 1 is a schematic diagram of an image system 100 according to some embodiments of the present disclosure.

As illustrated in FIG. 1, the image system 100 includes a transmitter device 110 and a receiver device 120. In some embodiments, the transmitter device 110 or the receiver device 120 can be a laptop computer, a desktop computer, a tablet computer, a smart phone, a wearable electronic device, an automotive electronic device, or other electronic devices with similar functions.

As illustrated in FIG. 1, the transmitter device 110 includes a processor 111, a memory 112, an input interface 113, a camera 114, and a display 115. The processor 111 is coupled to the memory 112, the input interface 113, the camera 114 and the display 115.

In some embodiments, the processor 111 can be a central processor, a microprocessor, or other circuits with similar functions.

In some embodiments, the memory 112 can be implemented by a non-transitory computer readable storage medium. The non-transitory computer readable storage medium is, for example, a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

In some embodiments, the input interface 113 can be a touch panel in the transmitter device 110. In some embodiments, the input interface 113 can be a mouse paired with the transmitter device 110 through wires or a mouse paired with the transmitter device 110 wirelessly (e.g., a wireless mouse paired with a desktop computer). In some embodiments, the input interface 113 can be a touchpad in the transmitter device 110 (e.g., a touchpad in a notebook computer). In some embodiments, the input interface 113 can be integrated with the display 115 to form a touch display panel in the transmitter device 110 (e.g., a touch display panel in a tablet computer).

In some embodiments, the camera 114 can be an embedded camera disposed in the transmitter device 110, as shown in FIG. 1. In some other embodiments, the camera 114 can be an external camera paired with the transmitter device 110 through wires or an external camera paired with the transmitter device 110 wirelessly. The memory 112 can store a driver program DP1 of the camera 114. The processor 111 can execute instructions in the driver program DP1 to make to the camera 114 operate normally.

In some embodiments, the display 115 can be a display panel in the transmitter device 110 (e.g., a screen of a laptop computer).

Similarly, the receiver device 120 includes a processor 121, a memory 122, an input interface 123, a camera 124, and a display 125.

The implementations, coupling, and functions of the processor 121, the memory 122, the input interface 123, the camera 124, and the display 125 are similar to those of the processor 111, the memory 112, the input interface 113, the camera 114, and the display 115 respectively, so they are not described herein again. The memory 122 can store a driver program DP2 of the camera 124. The processor 121 can execute instructions in the driver program DP2 to make to the camera 124 operate normally.

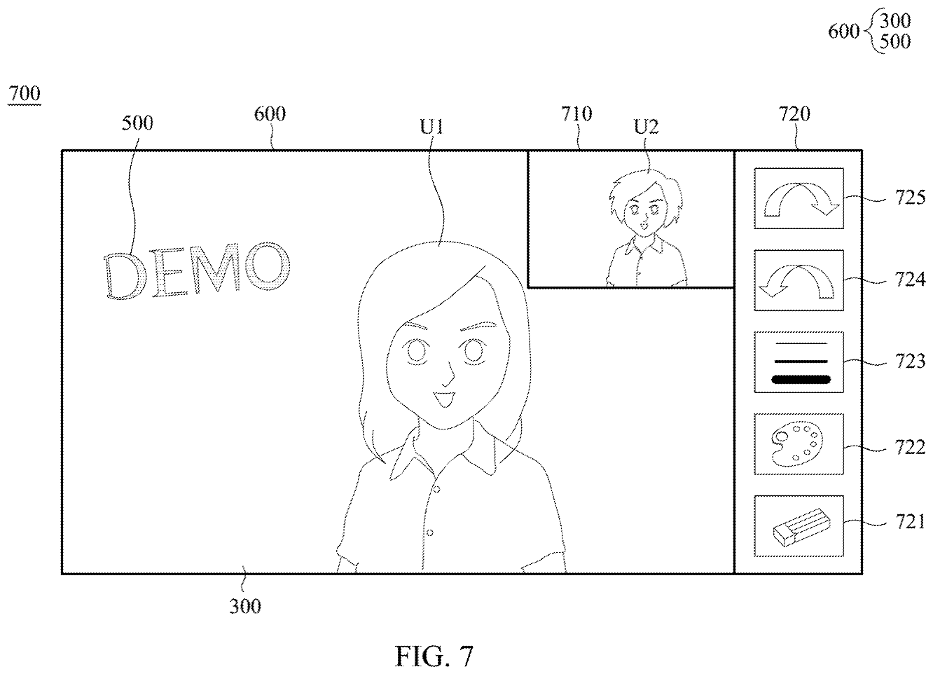

In practical applications, the transmitter device 110 and the receiver device 120 can be connected to each other through a network to transmit various data. For example, one user (e.g., a user U1 in FIG. 7) can operate the transmitter device 110 and another user (e.g., a user U2 in FIG. 7) can operate the receiver device 120 to join a video conference.

The quantity of the devices in the image system 100 is merely for illustration, and other suitable quantities are within the contemplated scopes of the present disclosure. For example, the image system 100 includes three or more than three devices to join the video conference.

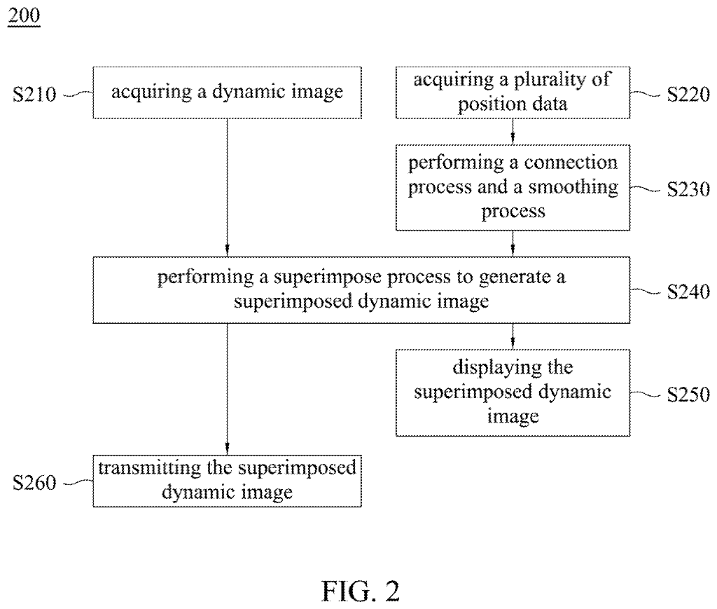

Reference is made to FIG. 2. FIG. 2 is a flow diagram of an image processing method 200 according to some embodiments of the present disclosure.

In some embodiments, the image processing method 200 can be implemented to the image system 100 in FIG. 1. In other words, the processor 111 can execute the driver program DP1 of the camera 114 to perform the image processing method 200.

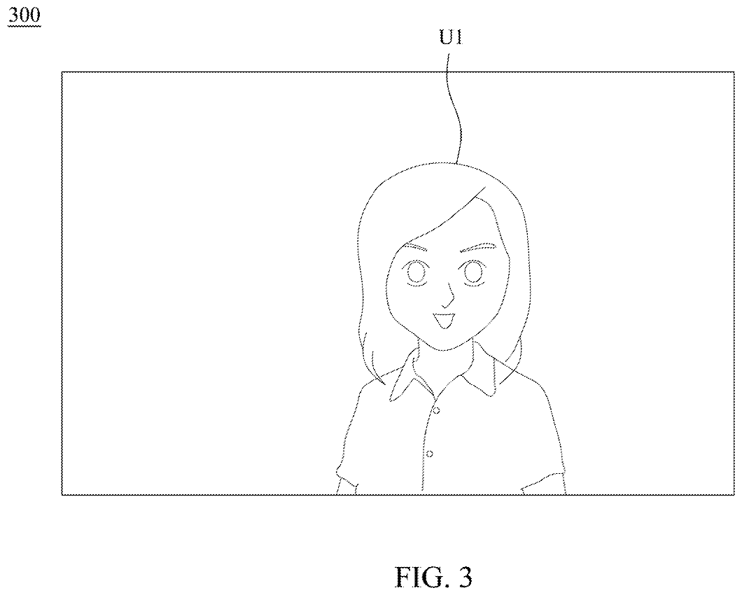

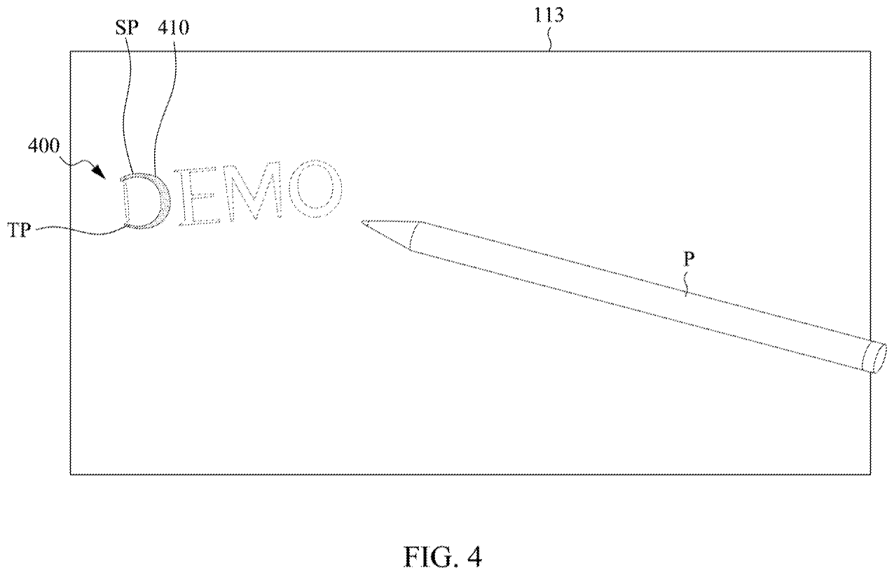

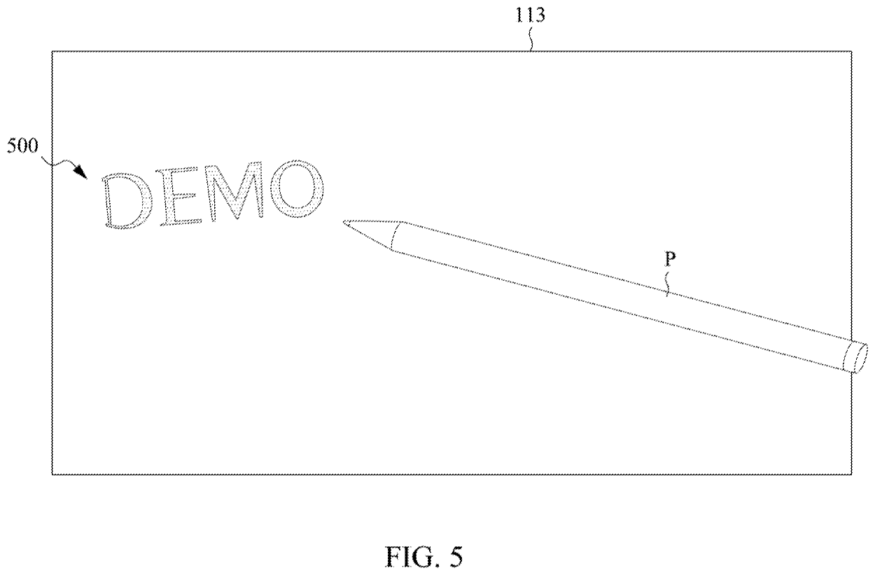

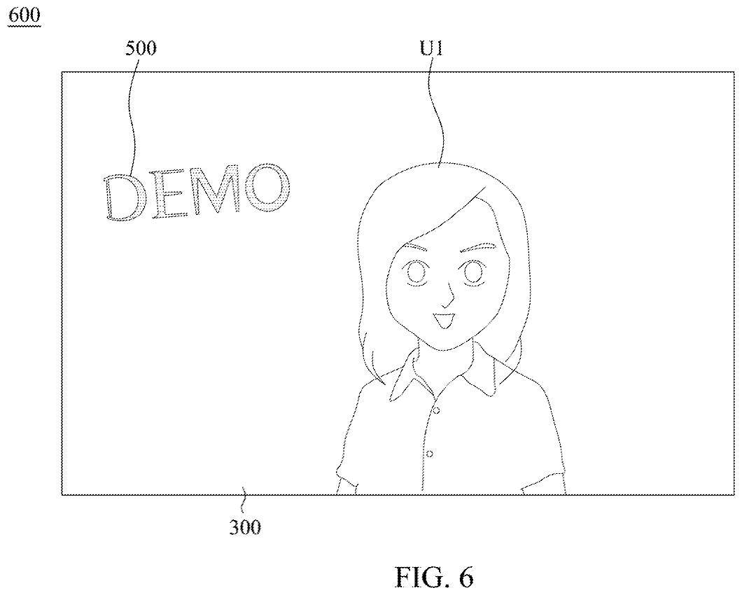

For better understanding, the image processing method 200 is described in following paragraphs with reference to the image system 100 in FIG. 1 and FIGS. 3-6. FIG. 3 is a schematic diagram of a dynamic image 300 according to some embodiments of the present disclosure. FIG. 4 is a schematic diagram of input information 400 according to some embodiments of the present disclosure. FIG. 5 is a schematic diagram of handwriting line information 500 according to some embodiments of the present disclosure. FIG. 6 is a schematic diagram of a superimposed dynamic image 600 according to some embodiments of the present disclosure.

As illustrated in FIG. 2, the image processing method 200 includes operation S210, operation S220, operation S230, operation S240, and operation S250.

In operation S210, the driver program DP1 is executed to acquire a dynamic image. For example, the processor 111 in the transmitter device 110 can execute the driver program DP1 of the camera 114 such that the camera 114 can capture the dynamic image 300 instantly (e.g., instant video of the user U1), as shown in FIG. 3.

In operation S220, the driver program DP1 is executed to acquire a plurality of position data of input information, in which the position data is associated with the transmitter device 110. To be more specific, the position data can be coordinates on the input interface 113. For example, in a situation that the camera 114 captures the dynamic image 300 instantly (i.e., the processor 111 executes the driver program DP1), when the user U1 intends to use handwriting to deliver some specific information (e.g., content that is difficult to explain orally or to pronounce) to the user U2, the user U1 can operate a stylus pen P to write on the input interface 113 (e.g., a touch panel), as shown in FIG. 4. Accordingly, the processor 111 can acquire a plurality of touch coordinates of the stylus pen P on the touch panel. These touch coordinates can be the aforementioned position data.

Since a pressure sensor can be disposed in the stylus pen P, in the embodiments of the stylus pen P, the processor 111 can further acquire a plurality of pressure data in operation S220. As illustrated in FIG. 4, a start position SP is the starting position of a segment 410, and an end position TP is the end position of the segment 410. In general, the pressure corresponding to the start position SP changes from small to large (the brushstroke changes from light to heavy), and the pressure corresponding to the end position TP changes from large to small (the brushstroke changes from heavy to light). Accordingly, when the user U1 operates the stylus pen P to touch the touch panel, the pressure sensor in the stylus pen P can sense the pressure corresponding to each touch coordinate. The stylus pen P can send the pressure data back to the processor 111. Accordingly, the processor 111 can acquire the pressure data and determine the start position SP and the end position TP according to the pressure data and the aforementioned position data.

In operation S230, the driver program DP1 is executed to perform a connection process and a smoothing process according to the aforementioned position data and the aforementioned pressure data. As described above, the processor 111 can determine the start positions SP and the end positions TP of different segments according to the aforementioned position data and the aforementioned pressure data. Accordingly, with the touch timing of different positions, the processor 111 can determine the connecting orders of the segments and the thicknesses of the different positions in the segments (e.g., the positions near the start position SP and the end position TP are thinner, and the positions between the start position SP and the end position TP are thicker). Then, the processor 111 can perform the smoothing process on the segments according to the Bezier curve, the quadratic curve, or other method. In other words, the processor 111 can perform the connection process and the smoothing process according to the touch coordinates and the pressure data sent by the stylus pen P to generate the handwriting line information 500, as shown in FIG. 5.

However, the present disclosure is not limited to the handwriting line information. In some other embodiments, a user can utilize the stylus pen P to draw or to input label information. In other words, the input information of the present disclosure can be draw information or other label information.

In addition, the present disclosure is not limited to the embodiments of the stylus pen. A user can utilize a mouse or a finger to write, to draw, or to input label information. In other words, the position data can be mouse cursor coordinates on the window, touch coordinates of the fingers on the touchpad, or touch coordinates of the fingers on the touch display panel. In these embodiments, the pressure data can be a fixed value (e.g., 0). Since the pressure data is a fixed value, the processor 111 can perform the connection process and the smoothing process (e.g., operation S230) only according to the mouse cursor coordinates or the touch coordinates of fingers. The processor 111 can also perform the connection process and the smoothing process (e.g., operation S230) according to the coordinates and the pressure data being the fixed value. In the embodiments of the pressure data being the fixed value, the thickness of the entire segment can be identical.

In operation S240, the driver program DP1 is executed to perform a superimpose process on the input information and the dynamic image 300 according to the position data. For example, the processor 111 can dispose the handwriting line information 500 in FIG. 5 at an upper layer (upper figure layer) above the dynamic image 300 in FIG. 3, and the handwriting line information 500 is arranged at a corresponding position above the dynamic image 300 according to the coordinates such that the handwriting line information 500 and the dynamic image 300 can be superimposed to generate the superimposed dynamic image 600, as shown in FIG. 6.

In some embodiments, before the superimpose process, the processor 111 can execute the driver program DP1 to perform a scaling adjustment process on the handwriting line information 500 according to a resolution of the display 115 or an aspect ratio of the display 115. For example, when the solution of the display 115 is lower, the processor 111 can enlarge a size of the handwriting line information 500. When the solution of the display 115 is higher, the processor 111 can shrink the size of the handwriting line information 500. For example, the processor 111 can adjust an aspect ratio of the handwriting line information 500 to be close to or identical to the aspect ratio of the display 115.

In some embodiments, after the scaling adjustment process, the processor 111 can adjust at least one characteristic of the handwriting line information 500 according to the dynamic image 300. The characteristic is, for example, a color, a thickness, or an outline. For example, when the color style of the dynamic image 300 is a light color style, the processor 111 can adjust the handwriting line information 500 to be a dark color style such that the handwriting line information 500 becomes more visible. For example, when the color style of the dynamic image 300 is a dark color style, the processor 111 can bold the handwriting line information 500 such that the handwriting line information 500 becomes more visible. For example, when the colors style of the dynamic image 300 is complex, the processor 111 can add an outline for the handwriting line information 500 such that the handwriting line information 500 becomes more visible.

In some other embodiments, the characteristic of the handwriting line information 500 can be adjusted before the size of the handwriting line information 500 is adjusted. In some other embodiments, the characteristic of the handwriting line information 500 and the size of the handwriting line information 500 can be adjusted synchronously to save the overall processing time.

In operation S250, the driver program DP1 is executed to display the superimposed dynamic image 600. For example, the processor 111 can execute the driver program DP1 such that the display 115 (e.g., a touch panel or a screen) displays the superimposed dynamic image 600. Accordingly, the user U1 can see the superimposed dynamic image 600 through the display 115, and the superimposed dynamic image 600 is generated by superimposing the dynamic image 300 and the handwriting line information 500.

In operation S260, the driver program DP1 is executed to transmit the superimposed dynamic image 600 to the receiver device 120. For example, the processor 111 can execute the driver program DP1 to transmit the superimposed dynamic image 600 to the receiver device 120. The display 125 in the receiver device 120 can display the superimposed dynamic image 600 simultaneously for the user U2 to see. Accordingly, the user U2 not only sees the dynamic image of the user U1 (e.g., the facial expression of the user U1 in the dynamic image 300) but also learns the specific information that the user U1 intends to deliver (e.g., the content of the handwriting line information 500).

In some related approaches, when a user in the video conference intends to deliver some specific information to another user in the video conference, the user needs to set up an additional hardware device (e.g., a physical whiteboard) behind him and write the specific information on the additional hardware device. In addition, in some other related approaches, a camera driver program and an additional program (e.g., additional drawing software) are executed at the same time and a user needs to write the specific information on the window of the additional program. However, these methods increase hardware cost or are inconvenient to use.

Compared to the aforementioned related approaches, the image processing method 200 of the present disclosure does not need additional hardware devices (e.g., a physical whiteboard). In addition, the present disclosure can utilize a single driver program DP1 to superimpose the dynamic image 300 and the input information (handwriting line information 500) to generate the superimposed dynamic image 600. Then, the superimposed dynamic image 600 can be displayed in a single window. Accordingly, interactivity and communication convenience of dynamic images can be improved. Since the present disclosure only uses one driver program and one window, the present disclosure does not require turning on a plurality of programs and does not need to switch between the windows.

References are made to FIG. 1 and FIG. 7. FIG. 7 is a schematic diagram of a video conference image 700 according to some embodiments of the present disclosure.

When the user U1 and the user U2 join the video conference, the processor 111 can execute the driver program DP1 and the processor 121 can execute the driver program DP2. The display 115 can display the video conference image 700.

As illustrated in FIG. 7, the video conference image 700 is a video window. The video window includes the aforementioned superimposed dynamic image 600, a dynamic image sub-window 710 for displaying the dynamic image of the user U2, and an operation sub-window 720.

The video displayed on the dynamic image sub-window 710 can be captured by the camera 124 toward the user U2.

In addition, In some embodiments, the operation sub-window 720 includes a control region 721, a control region 722, a control region 723, a control region 724, and a control region 725. The user U1 can utilize the stylus pen P, a mouse, or a finger to select the control region 721, the control region 722, the control region 723, the control region 724, and the control region 725. For example, the user U1 can select the control region 721 to delete the entire the handwriting line information 500 in the superimposed dynamic image 600 and keep the dynamic image 300 in the superimposed dynamic image 600. Accordingly, the user U1 can input other input information. In addition, the user U1 can select the control region 722 to change the color of the handwriting line information 500, or select the control region 723 to change the thickness of the handwriting line information 500. In addition, the user U1 can select the control region 724 to delete one segment corresponding to one previous stroke or to delete a plurality of segments corresponding to a plurality of previous strokes in the handwriting line information 500, or the user U1 can select the control region 725 to restore one deleted segment or a plurality of deleted segments. In some other embodiments, the user U1 can utilize different hotkeys in input interface 113 (e.g., the keyboard) to perform the operations of the control region 721, the control region 722, the control region 723, the control region 724 and the control region 725 respectively. In other words, the user U1 can delete the entire the handwriting line information 500, delete or restore one or more segments in the handwriting line information 500, or adjust the characteristic of the handwriting line information 500.

In addition, as described above, the handwriting line information 500 can be disposed at the upper layer above the dynamic image 300. The handwriting line information 500 at the upper layer can be a movable object, and the user U1 can move the position of the handwriting line information 500 according to actual needs. For example, the user U1 can use the stylus pen P, a mouse, or a finger to move the handwriting line information 500 from an upper left position relative to the dynamic image 300 (as shown in FIG. 7) to a lower right position relative to the dynamic image 300. In other words, the user U1 can move the position of the handwriting line information 500 according to actual needs.

As described above, the image processing method of the present disclosure does not need additional hardware devices (e.g., a physical whiteboard) and can utilize a single driver program (e.g., a driver program of a camera) to superimpose the input information and the dynamic image so as to display the superimposed image instantaneously. Accordingly, interactivity and communication convenience of dynamic images can be improved. Overall, the present disclosure has advantages of simple structures and ease to use.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image processing method, comprising:
executing, by a transmitter device, a driver program of a camera to acquire a dynamic image;
executing, by the transmitter device, the driver program to acquire a plurality of position data of input information, wherein the plurality of position data is associated with the transmitter device;
executing, by the transmitter device, the driver program to perform a superimpose process on the input information and the dynamic image according to the plurality of position data so as to generate a superimposed dynamic image; and
executing, by the transmitter device, the driver program to display the superimposed dynamic image.

2. The image processing method of claim 1, wherein the input information is handwriting line information.

3. The image processing method of claim 2, wherein the plurality of position data includes a plurality of touch coordinates.

4. The image processing method of claim 3, further comprising:
executing, by the transmitter device, the driver program to receive a plurality of pressure data from a stylus pen; and
executing, by the transmitter device, the driver program to perform a connection process and a smoothing process according to the plurality of position data and the plurality of pressure data so as to generate the handwriting line information.

5. The image processing method of claim 4, further comprising:
executing, by the transmitter device, the driver program to determine a start position of the handwriting line information and an end position of the handwriting line information according to the plurality of pressure data.

6. The image processing method of claim 4, further comprising:
executing, by the transmitter device, the driver program to perform a scaling adjustment process on the input information according to a resolution of a display or an aspect ratio of the display.

7. The image processing method of claim 4, further comprising:
executing, by the transmitter device, the driver program to adjust at least one characteristic of the handwriting line information,
wherein the at least one characteristic includes a color, a thickness, or an outline.

8. The image processing method of claim 1, wherein in the superimposed dynamic image, the input information is disposed at an upper layer above the dynamic image, and the input information is a movable object.

9. The image processing method of claim 1, further comprising:
executing, by the transmitter device, the driver program to transmit the superimposed dynamic image to a receiver device; and
displaying, by the receiver device, the superimposed dynamic image.

10. The image processing method of claim 1, wherein the plurality of position data includes a plurality of mouse cursor coordinates.

11. A non-transitory computer readable storage medium configured to store a driver program of a camera, wherein when a processor in a transmitter device executes the driver program, the processor performs following operations:
acquiring a dynamic image;
acquiring a plurality of position data of input information, wherein the plurality of position data is associated with the transmitter device;
performing a superimpose process on the input information and the dynamic image according to the plurality of position data so as to generate a superimposed dynamic image; and
controlling a display in the transmitter device to display the superimposed dynamic image.

12. The non-transitory computer readable storage medium of claim 11, wherein the input information is handwriting line information.

13. The non-transitory computer readable storage medium of claim 12, wherein the plurality of position data includes a plurality of touch coordinates.

14. The non-transitory computer readable storage medium of claim 13, wherein when the processor executes the driver program, the processor further performs following operations:
receiving a plurality of pressure data from a stylus pen; and
performing a connection process and a smoothing process according to the plurality of position data and the plurality of pressure data so as to generate the handwriting line information.

15. The non-transitory computer readable storage medium of claim 14, wherein when the processor executes the driver program, the processor further performs following operations:
determining a start position of the handwriting line information and an end position of the handwriting line information according to the plurality of pressure data.

16. The non-transitory computer readable storage medium of claim 14, wherein when the processor executes the driver program, the processor further performs following operations:
performing a scaling adjustment process on the input information according to a resolution of a display or an aspect ratio of the display.

17. The non-transitory computer readable storage medium of claim 14, wherein when the processor executes the driver program, the processor further performs following operations:
adjusting at least one characteristic of the handwriting line information,
wherein the at least one characteristic includes a color, a thickness, or an outline.

18. The non-transitory computer readable storage medium of claim 11, wherein in the superimposed dynamic image, the input information is on an upper layer above the dynamic image, and the input information is a movable object.

19. The non-transitory computer readable storage medium of claim 11, wherein when the processor executes the driver program, the processor further performs following operations:
transmitting the superimposed dynamic image to a receiver device for the receiver device to display.

20. The non-transitory computer readable storage medium of claim 11, wherein the plurality of position data includes a plurality of mouse cursor coordinates.
